(19) United States
(12) Patent Application Publication
(10) Pub. No.: US 2025/0364853 A1
(43) Pub. Date: Nov. 27, 2025

(54) STATOR ASSEMBLY FOR AN ELECTRIC MOTOR, ELECTRIC MOTOR AND DRIVE DEVICE

(71) Applicant: Brose Fahrzeugteile SE & Co. Kommanditgesellschaft, Bamberg, Bamberg (DE)

(72) Inventors: Sascha KUNKEL, Würzburg (DE); David STARK, Würzburg (DE); Andreas WEISENSEE, Würzburg (DE); Michael SPETH, Gerbrunn (DE)

(21) Appl. No.: 19/289,296

(22) Filed: Aug. 4, 2025

Related U.S. Application Data
(63) Continuation of application No. PCT/EP2024/053210, filed on Feb. 8, 2024.

(30) Foreign Application Priority Data
Feb. 9, 2023 (DE) 10 2023 201 069.0

(51) Int. Cl. H02K 1/18; H02K 1/14; H02K 3/30; H02K 3/34; H02K 3/50

(52) U.S. Cl. CPC H02K 1/187; H02K 1/146; H02K 3/30; H02K 3/345; H02K 3/50

(57) ABSTRACT

A stator assembly for an electric motor having an external rotor configuration includes a stator main body having a shaft feedthrough and radially orientated stator teeth for a stator or rotary field winding with radially orientated connection wires. A stator insulation covers the stator main body at least in regions, and a hollow cylindrical stator carrier, which is connected to the stator main body and/or to the stator insulation, protrudes axially from the stator main body. An electric motor having the stator assembly, and a drive device for a motor vehicle having the electric motor and a drive housing, are also provided.

### CROSS-REFERENCE TO RELATED APPLICATION

This application is a continuation, under 35 U.S.C. § 120, of copending International Patent Application PCT/EP2024/053210, filed Feb. 8, 2024, which designated the United States; this application also claims the priority, under 35 U.S.C. § 119, of German Patent Application DE 10 2023 201 069.0, filed Feb. 9, 2023; the prior applications are herewith incorporated by reference in their entirety.

### FIELD AND BACKGROUND OF THE INVENTION

The invention relates to a stator assembly for a brushless electric motor in an embodiment as an external rotor (external rotor motor), in particular for a drive device, preferably as an adjustment drive, of a motor vehicle. The invention furthermore relates to an electric motor having such a stator assembly, and to a drive device, in particular a seat adjustment drive, having such an electric motor.

A stator assembly of that type is a constituent part of a brushless (electronically commutated) electric motor (external rotor motor) conceived as an external rotor, which—or the stator of which—is received within a housing of a drive device, for example. As an electric-motor adjustment drive of a motor vehicle, the drive device, for example by way of a gearbox coupled to the electric motor, drives an actuating element, in particular between two terminal positions, along an adjustment path. The stator assembly of the brushless electric motor typically has a stator main body having a number of stator teeth which are wound with coils that are connected so as to form a rotary field winding (stator winding). Moreover, the electric motor has a permanently excited rotor having a rotor shaft which is coupled, or able to be coupled, to the gearbox, for example. The drive device can be used or utilized as a seat adjustment drive, or else as a window regulator drive in the motor vehicle, for example.

A drive device, in particular for a window regulator, of a motor vehicle, is known from German Patent Application DE 10 2016 216 888 A1, corresponding to U.S. Pat. No. 11,828,098 B2. In the drive device, a brushless electric motor embodied as an external rotor motor as well as a motor electronics unit for actuating the latter are received in a housing (drive or gearbox housing). The brushless (electrically or electronically commutated) electric motor has a stator and a rotor which is configured as an external rotor and has a rotor shaft (drive shaft) that supports a worm, fixedly attached to the shaft, of a worm gear as an angle gear.

The stator has a stator main body having a number of stator teeth which are disposed in a star-shaped manner and are partially covered by shell-shaped slot caps as a stator or coil insulation, and are wound with a rotary field winding. The stator main body sits on a bushing-shaped or hollow-cylindrical stator carrier which is connected to the housing and which is penetrated by a rotor or drive shaft co-rotationally connected to the rotor. The housing at least partially receives the motor unit, wherein the stator is connected to a stationary housing portion by way of the bushing-shaped stator carrier.

The hollow-cylindrical stator carrier, which is produced, for example, by a sintering method (German Patent Application DE 10 2020 209 500 A1, corresponding to U.S. Publication No. 2023/0179035) or can be embodied as a rolled sheet-metal part (German Patent Application DE 10 2021 205 499 A1), fulfils several functions in the drive device. In particular, the stator carrier assumes the establishment of a connection between the stator and the housing (drive or gearbox housing), the establishment of a rigid connection to the stator main body, which is preferably embodied as the stator laminated core, and/or the mounting of the rotor or motor shaft, in particular by using a (radial or plain) bearing disposed in the stator main body.

### SUMMARY OF THE INVENTION

It is accordingly an object of the invention to provide a particularly suitable stator assembly for an electric motor in an external rotor embodiment, an electric motor having such a stator assembly and a drive device, in particular as a seat adjustment drive for a motor vehicle, having such an electric motor, or having a stator assembly of this type, which overcome the hereinafore-mentioned disadvantages of the heretofore-known devices of this general type and in which the stator assembly is constructed, or able to be produced, from ideally few individual parts, preferably for completion as the stator of the electric motor.

With the foregoing and other objects in view there is provided, in accordance with the invention, a stator assembly for an electric motor in an external rotor embodiment, including a stator main body having a shaft feedthrough which is concentric with a motor rotation axis, and having a number of radially oriented stator teeth for a stator or rotary field winding with a number of connection wires; a stator insulation which covers the stator main body at least in regions; and a hollow-cylindrical stator carrier which is connected to the stator main body and/or to the stator insulation and projects axially beyond the stator main body.

With the objects of the invention in view, there is also provided an electric motor in an external rotor embodiment, having a stator assembly according to the invention.

With the objects of the invention in view, there is concomitantly provided a drive device for a motor vehicle, having an electric motor according to the invention, and having a drive housing, in which the stator assembly inserted in the latter is held directly by the stator carrier, or is held by way of a connecting element which is disposed in particular in a form-locking manner, on the stator carrier, so as to be secured in particular in a form-locking manner preferably against rotation and/or to be axially secured.

Advantageous structural embodiments and refinements are the subject matter of the dependent claims.

The stator assembly provided for an electric motor in an external rotor embodiment has a stator main body and a stator insulation which covers the stator main body at least in part or in regions, and a hollow-cylindrical stator carrier which is connected to the stator main body and/or to the stator insulation. The stator main body has a shaft feedthrough, which is concentric with a motor rotation axis, for a motor or rotor shaft, and a number of radially oriented stator teeth for a stator or rotary field winding with a number of connection wires. The latter serve in particular as phase connectors for contacting a motor electronics unit. The stator carrier projects axially beyond the stator main body. The through-opening of the hollow-cylindrical stator carrier, which is coaxial with the motor rotation axis, is co-aligned with the shaft feedthrough of the stator main body provided with the stator insulation.

The stator assembly, or the electric motor having such a stator assembly, and the stator having the stator or rotary field winding, is preferably a constituent part of an electric-motor adjustment or drive device, preferably of, or for, a seat adjustment of a motor vehicle.

In an advantageous structural embodiment, the stator insulation is configured as an injection-molded plastic overmolding of the stator main body. The stator main body is preferably embodied as a laminated core of a number of stator lamination sheets. In the stator insulation, which is embodied or produced as an injection-molded plastic overmolding, end face-proximal free surfaces (pole shoes) of the stator teeth of the stator main body are suitably provided. The stator carrier is expediently likewise an injection-molded plastic part, or is embodied or produced as such.

The stator insulation and the stator carrier are preferably embodied or produced as an injection-molded plastic part(s). According to a suitable refinement, the stator insulation and the stator carrier are configured as a bi-component plastic part (injection-molded bi-component plastic part). In other words, the stator insulation, which covers the stator main body at least in regions, and the stator carrier are embodied as a bi-component plastic part or injection-molded plastic part, also referred to as bi-component plastic part hereunder. The stator carrier is suitably integrally molded, or overmolded, on the stator insulation which encloses or surrounds the stator main body at least in regions.

The plastics material of the stator insulation has ideally positive flow properties, in particular in comparison to the plastics material of the stator carrier. For this purpose, a glass fiber-reinforced polyamide material, or a polyamide material having a glass fiber component (e.g. of 30%), in particular a PA 6 GF30 material, can preferably be used. An easy-flowing material should be used for the stator insulation, in particular in order to be able to fill or produce thin wall thicknesses. A material which has an improved welding behavior should be used as the plastics material for the stator carrier, in order to be able to implement hot-caulking of contours for fastening the connection wires of the stator or rotary field winding. PA 6 GF30 material can likewise be used for the stator carrier.

A transition interface is formed between the stator insulation and the stator carrier. This transition interface expediently has an ideally large interface area or surface. The transition interface is suitably formed by a gear rim-type or crown-type contour on the stator insulation and a mating contour on the stator carrier, or includes such a contour. In other words, as opposed to, or in comparison to, a flat, a planar or a contour-free annular face, the transition interface is provided with, or formed by, uneven and surface-enlarging contours such as, for example the gear rim-type or crown-type or else wave-shaped (corrugated) contour or mating contour, in particular both on the carrier as well as on the insulation.

An in particular hollow-cylindrical axial appendage, which surrounds the shaft feedthrough, is expediently additionally or alternatively integrally molded on the stator insulation. The external diameter of this axial appendage is suitably equal to or only slightly smaller than the internal diameter of the stator carrier, in particular in the region or the carrier portion of the transition interface. In this way, a particularly large surface (area) for integrally molding the stator carrier to the stator insulation in the region of the transition interface is provided. Particularly advantageously, a materially integral connection, or a type of materially integral connection, between the stator carrier and the stator insulation is established in the region of the transition interface, in particular after the (plastics) materials (of the stator carrier or of the stator insulation) have cured.

According to a suitable refinement of the stator carrier, the latter has a radially raised contour having insertion slots for the connection wires. The connection wires which are disposed and/or guided in the insertion grooves are expediently bent radially upward outside and on the (end) side of the stator carrier that faces away from the stator main body. This enables an advantageous contacting of the connection wires with corresponding contacts of a motor electronics unit, or with a printed circuit board of the electronics unit.

The radially raised contour, or the contour region of the latter that forms or has the insertion slots, expediently extends across a sector (fragment) of a circle of the stator carrier, the latter preferably being circular in cross section. In particular in the case of six insertion slots, the sector (fragment) of the circle extends across an angular range between 90° and 180°, preferably (130±30)°. The connection wires are particularly advantageously fixed in the insertion slots by forming, in particular by hot-caulking, the material of the radially raised contour, or the contour region of the latter forming or having the insertion slots, and/or by forming the material of the slot flanks of the insertion slots.

The embodiment of the stator assembly for an electric motor in an external rotor embodiment, having a stator main body having a shaft feedthrough which is concentric with a motor rotation axis, and having a number of radially oriented stator teeth, and having a stator or rotary field winding with a number of connection wires which serve in particular as phase connectors, furthermore having a stator insulation which covers the stator main body at least in regions, and furthermore having a hollow-cylindrical stator carrier which is connected to the stator main body and/or to the stator insulation and projects axially beyond the stator main body, and has a radially raised contour with insertion slots for the connection wires which are fastened in the insertion slots by forming the material, in particular hot-caulking, the radially raised contour and/or the slot flanks of the insertion slots, represents an independent invention.

According to an expedient refinement, it is provided that a preferably annular connecting element having form-locking elements is disposed, or able to be disposed, on the stator carrier. The connecting element, preferably provided as a separate component, serves for mounting on the stator carrier and/or for securing the stator assembly in a housing, in particular in a drive, gearbox and/order electronics housing of an electric-motor drive or adjustment device, preferably for the seat adjustment, in a motor vehicle.

The separate connecting element is suitably a plastics material component or a plastic clip. The connecting element expediently has a main body which encompasses or encloses the stator carrier at least in part or in regions, preferably at least almost completely and has at least one latching or joining element for connecting to the stator carrier in a form-locking manner, and has at least one joining element or latching hook for securing the stator in the, or in a, housing (drive housing, gearbox housing or electronics housing). For this purpose, the stator carrier suitably has at least one counter-contour, for example a bead-type clearance, convexity or latching contour, which corresponds to the respective latching or joining element.

The housing suitably has a joining contour which interacts with the respective joining element of the connecting element, in particular in the form of a latching hook. This joining contour is expediently provided in the region of a housing-proximal electronics compartment, or in the region of a housing well, or in the region between the latter and the electronics compartment. The housing-proximal joining contour, which is assigned to the respective joining element, in particular to a pair of latching hooks or a number or plurality of latching hooks, of the connecting element, is advantageously configured as an undercut for the respective latching hook.

According to an expedient refinement, the connecting element has a number of axial grooves for receiving the in particular radially bent upward connection wires, this number in particular corresponding to the number of (phase) connection wires. The axial grooves are disposed in a receptacle grid, for example in a chamber-type molding of the connecting element. This receptacle grid is suitably oriented tangentially in terms of the annular main body of the connecting element, or in terms of the circular circumference of the stator carrier, and is radially spaced apart from the stator carrier.

According to a further expedient refinement, the stator carrier has a radially raised axial stay, or an axially extending radial rib. The latter expediently corresponds to a groove of the connecting element for securing the connecting element against rotation relative to the stator carrier. The radially raised axial stay, or the axially extending radial rib, of the stator carrier also suitably corresponds to a housing groove for positioning, or orientating, the stator assembly according to the intended use during insertion (push-fitting) into the, or a, (drive) housing.

The electric motor has a stator having the stator assembly, and having a rotary field or stator winding which is in particular formed from individual coils. The stator assembly has a stator main body having a stator insulation and a bushing-shaped or hollow-cylindrical stator carrier which, conjointly with the stator insulation, is preferably configured or embodied or produced as a bi-component plastic component. The electric motor has in particular a rotor which revolves about the stator and is provided with permanent magnets and has a rotor shaft coupled to the electric motor and guided by the stator assembly by way of the shaft feedthrough of the stator main body and the hollow-cylindrical stator carrier. The rotor shaft is mounted so as to be rotatable about the motor rotation axis, preferably at least also in the stator assembly. An in particular separate connecting element, which is advantageously provided, serves for mounting the stator carrier, and thus the stator assembly, or the stator, in a form-locking manner in the (drive) housing.

The drive device, which is in particular provided and specified as an electric-motor seat adjustment drive of a motor vehicle, has a brushless external-rotor electric motor having the stator assembly and a drive housing. In particular, the drive device has a connecting element which is preferably provided separately. The stator assembly inserted into the drive housing is held in the latter directly by the stator carrier, or preferably by way of the connecting element, in particular in a form-locking manner, preferably so as to be secured against rotation and to be axially secured.

The drive housing of the drive device suitably has an electronics compartment and/or a housing well in which the stator having the stator assembly with the stator or rotary field winding, or the pre-assembled stator-rotor assembly, as an electric motor is received or able to be inserted. The hollow-cylindrical stator carrier is suitably configured for receiving at least one bearing, in particular a plain bearing, or a bearing bushing for the rotor shaft. A bearing, in particular a plain bearing or a bearing bush, can also be disposed or received in the region of the shaft feedthrough of the stator main body at least partially overmolded with the stator insulation, and/or in the region of the transition interface.

The connection wires (coil or phase connection wires) of the rotary field or stator winding are preferably guided on corresponding contact points of a printed circuit board within the, or an, electronics compartment assigned to the housing, in order to wire corresponding coil (ends) of the stator or rotary field winding of the stator while forming, for example, a star connection or a delta connection.

The advantages achieved by the invention lies in particular in that the stator assembly having the expediently overmolded stator main body, or stator laminated core, and having the stator carrier again preferably overmolded or integrally molded thereon, has only a few individual parts, or requires correspondingly few process or production steps. As a result of the production of, or the capability to produce, such a bi-component stator assembly, insulating end disks or shell-type slot-box insulations as stator insulations can be dispensed with, in particular because necessary geometries can be reproduced in the overmolding. Additionally, the connection wires as wire outputs of the stator or rotary field winding can be reliably fixed by plastics material forming, for example by hot-caulking, of contours or insertion slots of the stator carrier, in particular in the position and/or orientation according to the intended use thereof.

Furthermore, bearing points and connecting or latching elements can also be attached in this stator assembly in a simple manner, in particular in the manner of press-fits. Moreover, additional process steps can be dispensed with due to individual components not, or no longer, being required. Furthermore, geometries for implementing further process steps can be attached to the stator carrier. A reduction of tolerance chains is also made possible to the extent of existing interfaces, and additional material does not have to be introduced (e.g. by welding). Furthermore advantageously, the attachment of flux aids on the inserted laminated core (recesses) is made possible, in particular in order to implement the production capability due to the preferably minor wall thicknesses of the stator insulation provided as an overmolding, or to implement an ideally suitable material flux.

Reliable fastening of the preferably radially bent upward connection wires (winding wire fastening) of the stator or rotary field winding can be advantageously implemented by the, in particular plastic, material forming of a carrier-proximal contour, or the insertion slots of the latter. As a result, the use of insulation displacement contacts for connecting the connection wires or winding wires (wire ends) of the coils disposed on the stator assembly, or of the stator or rotary field winding to the (motor) electronics can be dispensed with.

For this purpose, the connection wires or winding wires of the stator or rotary field winding are preferably first guided into the plastic slots (insertion slots) of the stator carrier. Subsequently, the material is deformed, for example using a heated die, in such a way that the plastics material closes the insertion slots and the connection wires or winding wires are securely fixed. After the winding process of the stator or rotary field winding, the connection wires or winding wires (wire ends) are suitably held securely in position in the slot base of the insertion slots on the stator assembly, before the (hot) caulking process is carried out.

Other features which are considered as characteristic for the invention are set forth in the appended claims.

Although the invention is illustrated and described herein as embodied in a stator assembly for an electric motor, an electric motor and a drive device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a stator assembly embodied as a bi-component plastic part (injection-molded bi-component plastic part), including a stator main body having stator teeth which are disposed in a star-shaped manner, having a stator insulation embodied as an overmolding, and having a stator carrier integrally molded (injection molded) thereon;

FIG. 2 is a longitudinal-sectional view of the stator assembly, which is taken along the line II-II in FIG. 1, in the direction of the arrows;

FIG. 3 is an exploded, perspective view of the stator assembly according to FIG. 1;

FIG. 4 is a longitudinal-sectional view of the stator assembly having two bearing points, in an illustration according to FIG. 2;

FIG. 5 is a perspective view of the stator assembly, which in terms of the stator insulation and of the stator carrier is embodied as a bi-component plastic part, having a stator or rotary field winding which is disposed on the stator teeth thereof and has connection wires that are guided in insertion slots and are bent radially upward (upright), in particular prior to forming the material of the insertion slots;

FIG. 6 is a perspective view of a separate connecting element having an annular main body and joining elements, in a perspective illustration;

FIG. 7 is a perspective view of the stator assembly having a connecting element which is disposed in a form-locking manner on the stator carrier, in an illustration according to FIG. 5;

FIG. 8 is a fragmentary, perspective view of the stator assembly according to FIG. 7 in an assembly position before being inserted into a drive housing;

FIG. 9 is a fragmentary, perspective view, which is taken along the line IX-IX in FIG. 10, in the direction of the arrows, of an electric-motor drive device including an external rotor electric motor inserted into the drive housing, having a stator-rotor assembly with the stator assembly;

FIG. 10 is a perspective view of the drive device according to FIG. 9 provided and specified as a seat adjustment drive; and

FIG. 11 is a perspective view of a drive device provided and specified as a window regulator drive, having a drive housing and an electric motor in an external rotor embodiment received therein.

### DETAILED DESCRIPTION OF THE INVENTION

In the figures, the axial direction A and the radial direction R are highlighted by arrows, and the motor or shaft axis (rotation axis) of a drive or a motor shaft is visualized using chain-dotted lines and denoted with D.

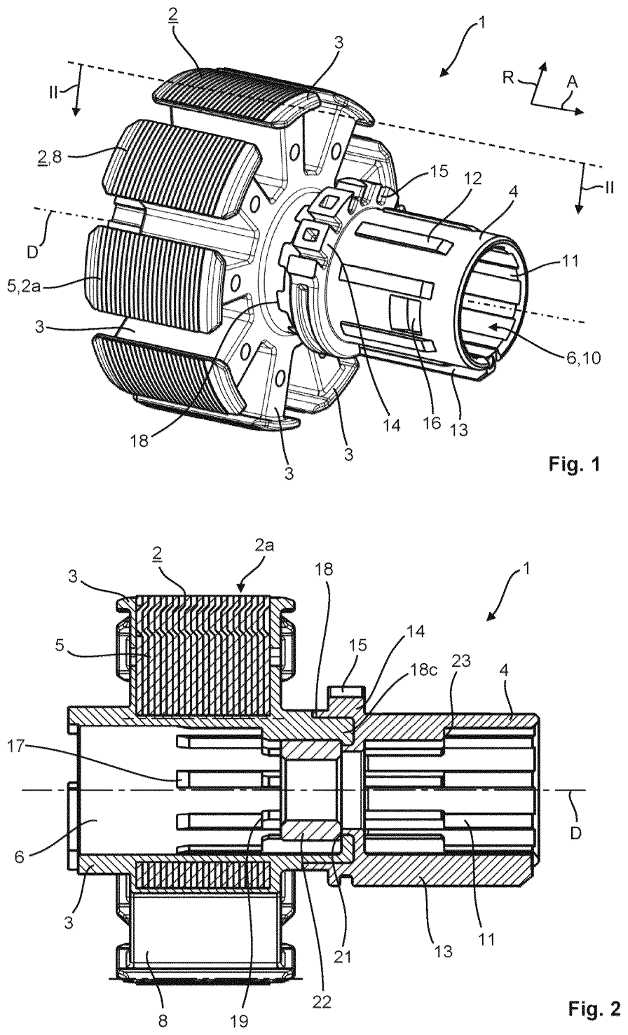

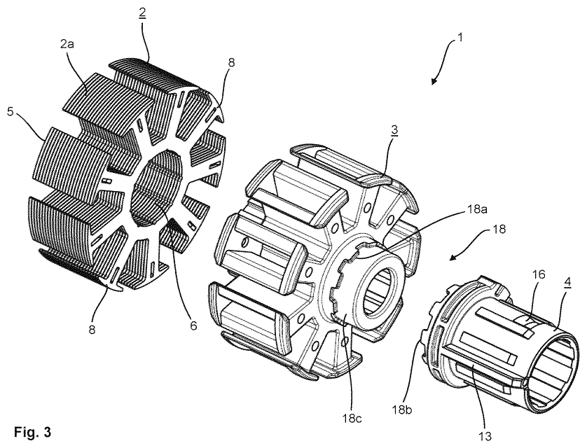

Referring now in detail to the figures of the drawings, in which equivalent parts are provided with the same reference signs, and first, particularly, to FIGS. 1 and 3 thereof, there is seen, in different illustrations, a stator assembly 1 having a stator main body 2, a stator insulation 3 and a stator carrier 4. FIG. 3 shows the stator main body 2, the stator insulation 3 and the stator carrier 4 separately from one another, so as to let characteristic details of the stator assembly 1 in the exemplary embodiment be comparatively clearly seen. The stator main body 2 is formed from a number of stator laminations 5 which are stacked so as to form a laminated core.

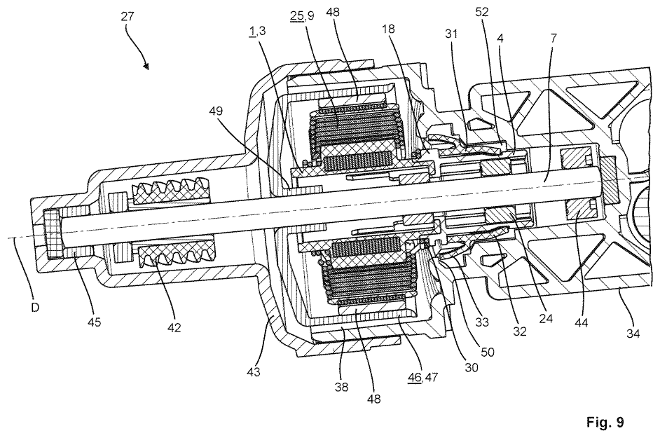

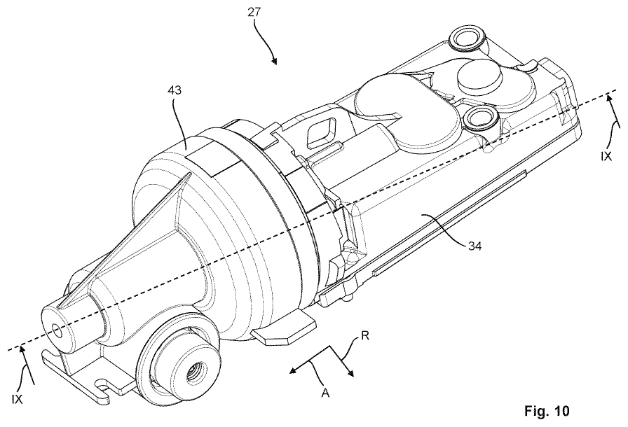

The stator main body 2 has a shaft feedthrough 6, which is concentric with the motor rotation axis D, for a motor or rotor shaft 7 (FIG. 9), and a number of radially oriented stator teeth 8, in the exemplary embodiment nine, for a stator or rotary field winding 9 (FIG. 5). The preferably hollow-cylindrical stator carrier 4 projects axially (in the axial direction A) beyond the stator main body 2. The through-opening 10 of the stator carrier 3, which is coaxial with the motor rotation axis D, is co-aligned with the shaft feedthrough 6 of the stator main body 2 provided with the stator insulation 3. The stator main body 2 has on the inner side, or on the internal wall, a number of radially inward-directed axial ribs 11 which are disposed so as to be distributed on the internal periphery. The stator main body 2 has on the external periphery a radially raised axial stay 13. The stator main body 2 has a radially raised axial stay 13 on the external periphery.

The stator carrier 4 has a radially raised contour 14 having insertion slots 15. This contour 14 extends across a partial circumferential region of the stator carrier 4, in particular as a function of the number of insertion slots 15. In the case of six insertion slots 15, corresponding to the exemplary embodiment, the contour 14 extends across 45%, for example. In the case of three insertion slots 15, the contour 14 extends across 25% of the (external) circumference of the stator carrier 4, for example. The stator carrier 4 has at least one bead-type clearance or latching contour 16, preferably two mutually opposite latching contours 16.

The stator insulation 3 is embodied as a plastics-material overmolding of the stator main body 2. Here, end face-proximal free surfaces (pole shoes) 2a of the stator teeth 8 of the stator main body 2 are provided in the stator insulation 3 embodied or produced as a plastics-material overmolding. The stator carrier 4 is likewise an injection-molded plastic part. The stator insulation 3 and the stator carrier 4 are preferably configured as bi-component plastic parts (injection-molded plastic parts). The stator carrier 4 here is injection-molded, or integrally molded, on the stator insulation 3 which surrounds the stator main body 2 while omitting the tooth end faces of the stator teeth 8. The plastics materials of the stator insulation 3 and of the stator carrier 4 have different hardnesses, wherein the plastics material of the stator insulation 3 is softer than that of the stator carrier 4.

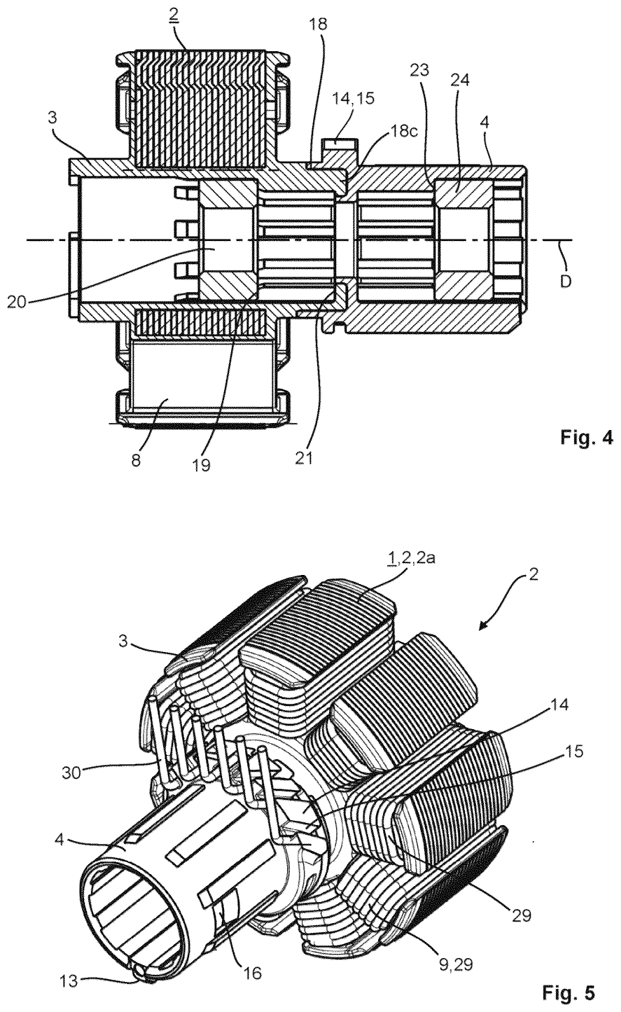

As can be seen from FIGS. 2 and 4, the stator insulation 3 has in the region of the shaft feedthrough 6 axial ribs 17 which are disposed so as to be distributed on the internal radius, or on the internal periphery. These axial ribs 17 are embodied so as to be reduced in the region of a transition interface 18 between the stator insulation 3 and the stator carrier 4, while forming a resting contour 19 in the internal diameter or the internal radius. This resting contour 19 serves as a support of a bearing 20, for example a radial and/or plain bearing, shown in FIG. 4, or as a bearing point (bearing seat) for the motor shaft 7. A further, or an alternative, resting contour 21 is provided in the transition interface 18 as a bearing point for a bearing 22 shown in FIG. 2.

Additionally or alternatively, such a bearing point in the form of a resting contour 23, formed by a reduction in the diameter of the axial ribs 11 there, is provided in the stator carrier 4 for a bearing 24 shown in FIG. 4. In other words, the stator assembly 1 has at least one bearing seat (bearing point) or else two or three bearing seats or bearing points for a (plain) bearing 20, 22, 24 for mounting the motor shaft 7. The axial ribs 11, 17 of the stator carrier 4, or of the stator insulation 3 of the stator main body 2, due to the local contact points provided by them, enable a reliable bearing seat, or press fit, of the respective bearing 20, 22, 24 at the corresponding bearing point.

As can be seen comparatively clearly from FIG. 3, the (mechanical) transition interface 18 is formed by a gear rim-type or crown-type contour 18a on the stator insulation 3, and by a preferably mating (counter) contour 18b on the stator carrier 4. It is important here that the transition interface 18, serving as a connection region, has the largest possible surface, or forms an ideally large surface.

A hollow-cylindrical axial appendage 18c, which surrounds the shaft feedthrough 6, is suitably integrally molded on the stator insulation 3. The external diameter of the axial appendage 18c is sized in such a manner, in particular equal to the internal diameter of the stator carrier 4 or only slightly smaller than the latter, that an ideally large surface (area) for integrally molding the stator carrier 4 on the stator insulation 3 is provided in the region of the transition interface 18.

After producing the molding process of the stator carrier 4 to the stator insulation 3, a preferably form-locking and materially integral connection, or a connection of a materially integral type, is produced in the region of the transition interface 18. The advantage of two different materials for the stator insulation 3 and the stator carrier 4 is derived from the fact that the material properties can be adapted to the requirements of the respective component (stator insulation 3 and stator carrier 4). In this way, an easy-flowing material can be used for injection-molding the thin wall thicknesses of the stator or laminated core insulation 3, and a material variant suitable for the hot-caulking process can be used. It is important that the materials of the components (stator insulation 3 and stator carrier 4) are mutually compatible and can form a materially integral connection.

The stator insulation 3 is suitably first produced as a component by injection-molding technology. While this component cools, for example after a few seconds, the stator carrier 4 as the second component is injection-molded on the first component (on the stator insulation 3). Due to high injection temperatures, the surface of the first component (the stator insulation 3) is fused in the process, and a materially integral connection of the two components (stator insulation 3 and stator carrier 4) is thus produced. In order to increase the strength of this connection, the contours 18a and 18b of the transition interface 18 are particularly advantageous, not least because the stator assembly 1 can thus particularly reliably absorb axial and radial forces.

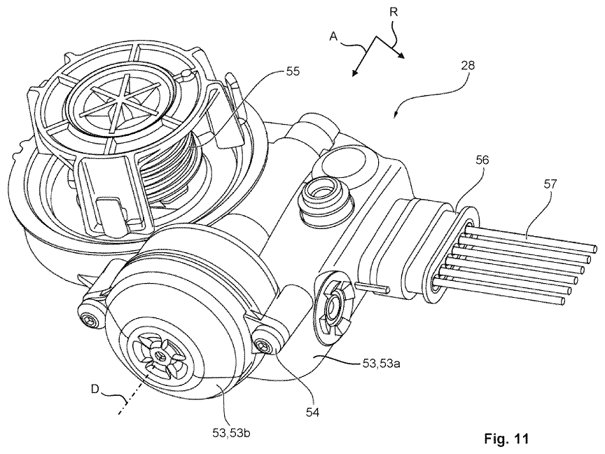

FIG. 5 shows the stator assembly 1 having the stator or rotary field winding 9 which is disposed on the stator main body 2 of the stator assembly 1, the stator main body 2 being overmolded or encased by the stator insulation 3. The stator assembly 1 having the stator or rotary field winding 9 forms a stator 25 of the electric motor 26, or of an electric motor conceived as an external rotor (FIG. 9). This electric motor 26 is suitably a constituent part of an electric-motor adjustment or drive device of a motor vehicle. FIGS. 9 and 10 show a device which preferably serves as a seat adjustment drive 27. FIG. 11 shows a device which preferably serves as a window regulator drive 28.

The stator or rotary field winding 9 is formed from coils 29 which are wound on the stator teeth 8 of the stator assembly 1 and are partially connected to one another, in particular for, or while, producing a star connection or a delta connection. In the exemplary embodiment, the stator or rotary field winding 9 has six connection wires 30 which serve in particular as phase connectors for contacting a motor electronics unit. The connection wires 30 are guided, or inserted, in the insertion slots 15 of the radially raised contour 14 of the stator carrier 4, and on the side of the contour 14 that faces away from the stator main body 2, are radially bent upward outside the insertion slots 15.

In this assembly state, or process step, the contour 14, or the insertion slots 15, in particular in the region of the slot flanks of the latter, are formed, for example by hot-caulking. As a consequence of this material forming of the contour 14, or of the insertion slots 15, or the slot flanks thereof, the connection wires 30 are reliably fastened to the stator assembly 1, and thereon on the stator carrier 4 of the latter, in their position or orientation according to the intended use. This enables advantageous contacting of the connection wires 30 with corresponding contacts of a motor electronics unit, or with a printed circuit board of the electronics unit.

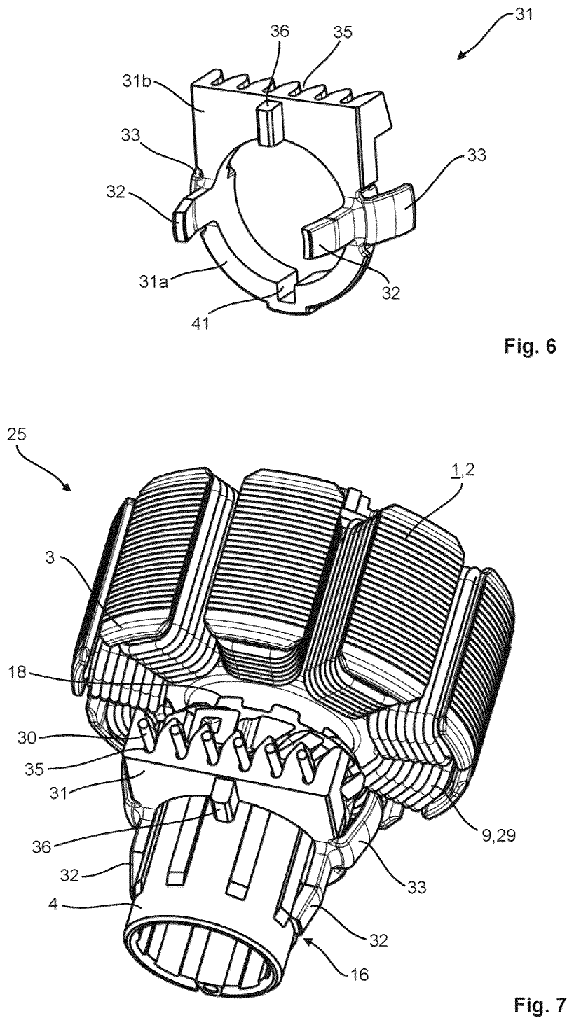

FIG. 6 shows a connecting element 31 having form-locking elements 32, 33 for mounting on the stator carrier 4, on the one hand, and for securing the stator assembly 1, or the stator 25, in a housing 34, in particular in a drive housing, gearbox housing and/or electronics housing of the electric-motor drive or adjustment device 27, 28, preferably of the seat adjustment drive 27, of a motor vehicle. The separate connecting element 31 is a plastics-material component or a plastic clip.

As can be seen in conjunction with FIGS. 7 to 9, the connecting element 31 has a main body 31a which encompasses or encloses the stator carrier 4 at least in part or in regions, preferably at least almost completely, and has in the exemplary embodiment two latching elements as form-locking elements 32 for the form-locking connection to the stator carrier 4, and having latching hooks as form-locking elements 33 for securing the stator 25 in the housing 34.

In the case of a connecting element 31 being attached to the stator carrier 4, the latching elements 32 engage in the (corresponding) clearances 16 of the stator carrier 4, in particular while establishing a form-locking connection. The connecting element 31 has a number of axial grooves 35 corresponding to the number of (phase) connection wires 30 for receiving the radially upward bent connection wires 30. The axial grooves 35 are disposed in a tangentially oriented receptacle grid which is radially spaced apart from the stator carrier 4 in a comb-type molding 31b of the connecting element 31.

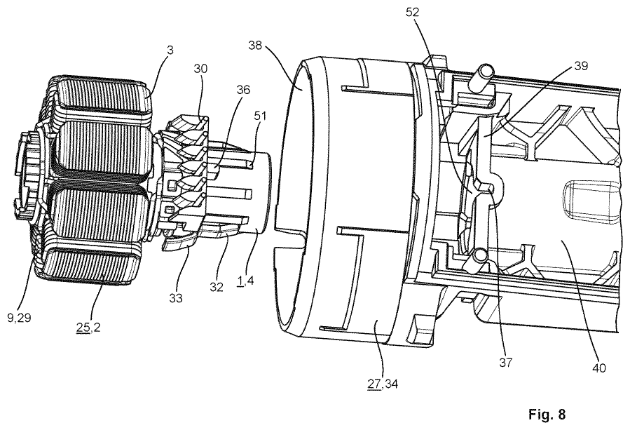

The connecting element 31 moreover has a joining dowel 36. The latter, for exactly positioning the stator 25 in the housing 34, corresponds to a joining groove 37 provided in the latter, when the stator 25 is inserted by way of a housing well 38 open on one side into the housing 34 (FIG. 8). The joining groove 37 is provided in a housing-proximal separation wall, or separation point 39, between the housing well 38 and an electronics compartment or electronics housing 40 of the housing 34. A motor electronics unit, or a printed circuit board, which for contacting with the connection wires 30 of the stator or rotary field winding 9 has corresponding connection or contact points, is received in a manner not illustrated in more detail in the electronics compartment or housing 40.

The connecting element 31 furthermore has a radial groove 41. The axial stay 13 of the stator carrier 4 engages therein when the connection element 31 is attached to the stator carrier 4, so as to position, or secure against rotation, the latter relative to the stator carrier 4.

FIGS. 9 and 10 show the drive device, preferably provided as a seat adjustment drive 27, wherein FIG. 9 is a fragmentary, longitudinal section taken along the line IX-IX in FIG. 10, which is a perspective illustration.

As can be seen in FIG. 9, the stator 25 is inserted in the (drive) housing 34 by way of the housing well 38. The stator 25 herein has the stator assembly 1 having the stator main body 2, and having the stator carrier 4 integrally molded on the stator insulation 3, and having the connecting element 31 disposed thereon. The motor shaft 7 is introduced in portions into the housing 34 by way of the shaft feedthrough 6, not referred to in more detail here, and the through-opening 10 of the stator assembly 1. A further shaft portion of the motor shaft 7, on which a worm 42 is disposed co-rotationally or so as to be fixed to the shaft, is introduced into a housing part 43. The latter encompasses the housing well 38 of the housing 34 of the seat adjustment drive 27 in the manner of a cuff. The motor shaft 7 is rotatably mounted in the stator assembly 1, presently embodied with two bearings or bearing points, in particular with the bearing 24, and in a bearing 44 which is disposed in the housing 34. A further bearing 45 for the motor shaft 7 is located in the housing part 43.

A rotor 46, having a pot-type rotor housing 47 and having permanent magnets 48 disposed on the cylindrical internal wall of the latter, is connected to the motor shaft 7 co-rotationally, or so as to be fixed to the shaft. For this purpose, the rotor housing 47 has a shaft leadthrough 49 which is press-fitted to the motor shaft 7. The stator 25 and the rotor 46 revolving about the latter form the external-rotor electric motor 26 of the seat adjustment drive 27. The worm 42 meshes, in a manner not illustrated in more detail, with a gear wheel, for example while forming a (90°) angle gear.

As can likewise be seen in FIG. 9, the housing 34 has a joining contour 50 which interacts with the form-locking elements or latching hooks 33 of the connecting element 30. This joining contour 50 is suitably disposed in the region between the housing well 38 and the electronics compartment 40.

In the case of a stator 25 being introduced by way of the housing well 38, or in the case of a pre-assembled electric motor 26 as a stator-rotor assembly 25, 46, the latching hooks 33 of the connecting element 30 sitting on the stator carrier 4 latch into a joining contour 50 of the housing 34, which is effective as an undercut for the latching hooks 33. For this purpose, in the position or orientation of the stator 26 or of the electric motor 26 according to the intended use in the housing 34, the latching hooks 33 engage behind the housing-proximal joining contour 50.

The securing mechanism caused by the connecting element 31 between the stator carrier 4 and the housing 34 is preferably an axial securing mechanism of the stator 25, or of the stator-rotor assembly 25, 46, of the electric motor 26 in relation to sliding out of the housing 34 in the axial direction A, on the one hand. On the other hand, an anti-rotation safeguard of the stator 25, or of the stator-rotor assembly 25, 46 within the housing 34, or the connecting element 30, in relation to the stator carrier 4 is established, the connecting element 31 sitting on the latter in the assembled state.

In particular additionally, the axial webs 12, which preferably have an introduction ramp 51, which can be seen in FIG. 1 and is indicated in FIG. 8, enable a reliable press-fit of the stator assembly 1 in the housing 34. For this purpose, the housing preferably has a hollow-cylindrical joining well 52 (FIGS. 8, 9) into which the stator carrier 4 is inserted by way of a corresponding carrier portion. As a result, an advantageously additional, friction-locking or force-locking connection of the stator carrier 4, and thus of the stator assembly 1, of the stator 25, of the stator-rotor assembly 25, 46 and/or of the external-rotor electric motor 25 is established in the housing 34.

FIG. 11 shows an electric-motor drive device, which is particularly suitable as a window regulator drive 28, and which has a (drive) housing 53 formed in particular of a gearbox housing part 53a and a motor housing part 53b. Inserted into this (drive) housing 53 is the electric motor 26, embodied as an external-rotor motor, with the stator assembly 1 having the stator or rotary field winding 9, preferably so as to be secured against rotation and axially secured by the connecting element 30. The gearbox housing part 53a and the motor housing part 53b are releasably connected to one another and to the drive housing 53 by a flange connection, preferably screwed to one another using flange screws 54. A non-releasable connection, e.g. a welded connection, can also be provided. The external-rotor electric motor 26 in the exemplary embodiment as a driving element drives, in a manner not illustrated in more detail, by way of a gearbox, a cable drum 55 of a window regulator system.

The gearbox herein is a 90° angle gear, in particular a worm gear. The worm wheel of the latter, which is not visible and disposed in the gearbox housing part 53a, and is coupled to the cable drum 55 of the window regulator of a motor vehicle, the cable drum 55 being wrapped by a traction cable, meshes with a worm (not visible here) driven by the external-rotor electric motor 26. This worm sits in a manner not illustrated in more detail on the drive or rotor shaft of the electric motor, the rotor of the latter being co-rotationally connected to the rotor shaft. A connection plug 56 having connection lines 57 for supplying the drive device 28 with current and voltage, and for inputting and/or outputting control and/or sensor signals is plugged into a housing-proximal connection receptacle.

In summary, the invention relates to a stator assembly 1 for an external-rotor electric motor 26, including a stator main body 2 having radially oriented stator teeth 8 for a stator or rotary field winding 9 having radially oriented connection wires 30, and a stator insulation 3 which covers the stator main body 2 at least in regions, and having a hollow-cylindrical stator carrier 4 which is connected to the stator main body 2 and/or to the stator insulation 3 and which projects axially beyond the stator main body 2.

The claimed invention is not restricted to the exemplary embodiments described above. Rather, other variants of the invention can also be deduced by a person skilled in the art therefrom within the scope of the disclosed invention without departing from the subject matter of the claimed invention. In particular, furthermore, all of the individual features described in connection with the various exemplary embodiments can also be combined with one another in some other way within the scope of the disclosed claims without departing from the subject matter of the claimed invention.

Also, the solution described can be used not only in the specifically illustrated applications, but may also be used in a similar embodiment in other automotive applications, such as, for example, in door and rear hatch systems, in vehicle locks, in adjustable interior systems and in further electric adjustment drives in the vehicle.

The following is a summary list of reference numerals and the corresponding structure used in the above description of the invention:
1 Stator assembly
2 Stator main body
2a Free surface/pole shoe
3 Stator insulation
4 Stator carrier
5 Stator lamination
6 Shaft feedthrough
7 Motor/rotor shaft
8 Stator tooth
9 Stator/rotary field winding
10 Through-opening
11 Axial rib
12 Axial web
13 Axial stay
14 Contour
15 Insertion slots
16 Clearance/latching contour
17 Axial rib
18 Transition interface
18a Contour
18b Counter-contour
18c Axial appendage
19 Resting contour
20 Bearing
21 Resting contour
22 Bearing
23 Resting contour
24 Bearing
25 Stator
26 Electric motor
27 Drive device/seat adjustment drive
28 Drive device/window regulator drive
29 Coil
30 Connection wire
31 Connecting element
31a Main body
31b Molding
32 Form-locking/latching element
33 Form-locking element/latching hook
34 Drive/housing
35 Axial grooves
36 Joining dowels
37 Joining groove
38 Housing well
39 Intermediate wall/separation point
40 Electronics compartment/housing
41 Radial groove
42 Worm
43 Housing part
44 Bearing
45 Bearing
46 Rotor
47 Rotor housing
48 Permanent magnet
49 Shaft leadthrough
50 Joining contour/undercut
51 Introduction ramp
52 Joining well
53 Drive/housing
53a Gearbox housing part
53b Motor housing part
54 Flange screws
55 Cable drum
56 Connection plug
57 Connection line
A Axial direction
D Rotation axis
R Radial direction

1. A stator assembly for an electric motor having an external rotor configuration, the stator assembly comprising:
a stator main body having a shaft feedthrough being concentric with a motor rotation axis, said stator main body having a plurality of radially oriented stator teeth for a stator or rotary field winding with a plurality of connection wires;
a stator insulation covering said stator main body at least in regions; and
a hollow-cylindrical stator carrier connected to at least one of said stator main body or said stator insulation, said stator carrier projecting axially beyond said stator main body.

2. The stator assembly according to claim 1, wherein at least one of:
said stator insulation is configured as an injection-molded plastic overmolding, or
said stator carrier is an injection-molded plastic part.

3. The stator assembly according to claim 2, wherein said stator teeth of said stator main body have end face-proximal free surfaces being omitted from said injection-molded plastic overmolding.

4. The stator assembly according to claim 1, wherein said stator insulation covering said stator main body at least in regions and said stator carrier, are injection-molded plastic parts.

5. The stator assembly according to claim 4, wherein said injection-molded plastic parts are injection-molded bi-component plastic parts.

6. The stator assembly according to claim 1, wherein at least one of:
a transition interface is formed between said stator insulation and said stator carrier, or
said stator carrier is injection-overmolded or integrally molded on said stator insulation.

7. The stator assembly according to claim 6, wherein said transition interface is an enlarged-surface transition interface.

8. The stator assembly according to claim 1, wherein said stator insulation and said stator carrier are connected in a materially integral manner.

9. The stator assembly according to claim 8, wherein said stator insulation is formed of a first plastics material, and said stator carrier is formed of a second plastics material.

10. The stator assembly according to claim 8, wherein said stator insulation and said stator carrier are interconnected in a region of a transition interface.

11. The stator assembly according to claim 1, which further comprises at least one of:
a transition interface formed between said stator insulation and said stator carrier, said transition interface being formed by a gear rim-shaped or crown-shaped contour on said stator insulation and by a mating contour on said stator carrier, or
an axial appendage:
surrounding said shaft feedthrough and being integrally molded on said stator insulation, or
surrounding said shaft feedthrough, being integrally molded on said stator insulation and having an external diameter being equal to or slightly smaller than an internal diameter of said stator carrier in a region of said transition interface.

12. The stator assembly according to claim 11, wherein said axial appendage is hollow-cylindrical.

13. The stator assembly according to claim 1, wherein said stator carrier has a radially raised contour having insertion slots for at least a plurality of said connection wires of said stator or rotary field winding disposed on said stator main body.

14. The stator assembly according to claim 13, wherein said connection wires are fixed in said insertion slots by forming or hot-caulking a material of at least one of said radially raised contour or slot flanks of said insertion slots.

15. The stator assembly according to claim 1, which further comprises:
a housing; and
a connecting element disposed on said stator carrier;
said connecting element having form-locking elements at least one of mounted on said stator carrier or securing said stator carrier and said stator main body in said housing.

16. The stator assembly according to claim 15, wherein said connecting element is annular.

17. An electric motor having an external rotor configuration, the electric motor comprising the stator assembly according to claim 1.

18. A drive device for a motor vehicle, the drive device comprising:
the electric motor according to claim 17; and
a drive housing;
the stator assembly being inserted in said drive housing and held directly by said stator carrier or by a connecting element disposed on said stator carrier.

19. The drive device according to claim 18, wherein said connecting element is disposed in a form-locking manner on said stator carrier and is at least one of secured in a form-locking manner against rotation or axially secured.
